(19) United States
(12) Patent Application Publication
(10) Pub. No.: US 2025/0091232 A1
(43) Pub. Date: Mar. 20, 2025

(54) COMPENSATING ELEMENT

(71) Applicant: KRONES AG, Neutraubling (DE)

(72) Inventors: Stefan SCHERL, Bernhardswald (DE); Tobias EHRISMANN, Burglengenfeld (DE)

(21) Appl. No.: 18/888,447

(22) Filed: Sep. 18, 2024

(30) Foreign Application Priority Data
Sep. 18, 2023 (DE) 10 2023 125 162.7

(51) Int. Cl. B25J 19/00; B29C 64/153; B29K 75/00; B29K 77/00; B29L 31/00; B33Y 10/00; B33Y 80/00

(52) U.S. Cl. CPC B25J 19/0091; B29C 64/153; B33Y 10/00; B33Y 80/00; B29K 2075/00; B29K 2077/00; B29K 2995/0046; B29L 2031/7278

(57) ABSTRACT

The invention relates, inter alia, to an apparatus for connecting a gripper to a handling device. The apparatus has at least one compensating element for the purpose of compensating for position inaccuracies, with a toolholder for holding the gripper, a frame for connecting the compensating element to the handling device, and a plurality of elastically deformable connectors which connect the toolholder inside the frame to the frame in an elastically movable manner. The toolholder, the frame and the plurality of connectors are integrally connected as a single piece to one another.

### CROSS REFERENCE TO RELATED APPLICATIONS

This application claims the benefit under 35 U.S.C. § 119 (a) of German Patent Application No. DE 10 2023 125 162.7, filed Sep. 18, 2023 entitled COMPENSATING ELEMENT, and whose entire disclosure is incorporated by reference herein.

### TECHNICAL FIELD

The invention relates to an apparatus for connecting a gripper to a handling device, wherein the apparatus comprises at least one compensating element for the purpose of compensating for position inaccuracies. The invention further relates to a container processing system, to a method for producing the apparatus, and to a computer program product.

### TECHNICAL BACKGROUND

A so-called compensating element can, for example, be installed between a robot and its gripping tool in order to compensate for position inaccuracies of the workpiece being gripped, of the robot, of the gripper or for other disruptive influences.

Conventionally, such a compensating element can be constructed from many components. For example, a housing can be formed from a plurality of components, inside which a compensating body is movably mounted via elastic connecting elements (such as elastomers or springs). This movement can be made possible in the X and Y directions, or in the X, Y and Z directions. In the latter case, it may be necessary, for example, to realize an embedding in a further elastic connecting element that allows movement in the Z direction.

A disadvantage of the known prior art can be the relatively high weight of the compensating element due to the large number of components (mostly made of metal). This is particularly disadvantageous if the component to be gripped is very light. The mass of the compensating element will then be of the same order of magnitude or even greater than that of the component to be gripped. The high weight of the compensating element can therefore be a limiting factor in the dynamics of the handling movement. In addition, due to the large number of components, the complexity can be very high and therefore the assembly of the compensating element can be very complicated. Especially for less challenging gripping operations with, for example, low masses or accuracy requirements that are not extremely demanding, a conventional system based on the prior art is quickly over-dimensioned.

The invention is based on the object of creating an improved technique for compensating for position inaccuracies in the handling of objects, with which preferably at least some of the disadvantages mentioned above can be overcome.

### SUMMARY OF THE INVENTION

The object is achieved by the features of the independent claims. Advantageous developments are specified in the dependent claims and the description.

One aspect of the present disclosure relates to an apparatus for connecting a gripper to a handling device, preferably a handling robot. The apparatus has at least one, preferably substantially disk-shaped, compensating element for the purpose of compensating for position inaccuracies (e.g. of an object to be gripped, of the handling device and/or of the gripper). (Each of) the at least one compensating element(s) has:
a toolholder, preferably annular (e.g. circular) or tubular (e.g. round), for holding a gripper,
a, preferably annular (e.g. circular), frame for connecting the compensating element to the handling device, wherein the frame surrounds the toolholder as a frame, and preferably coaxially, and
a plurality of elastically deformable (e.g. elastically flexible) connectors which connect the toolholder inside the frame to the frame in an elastically movable manner.

The toolholder, the frame and the plurality of connectors are integrally connected as a single piece to one another.

Advantageously, the apparatus enables the functions of a complex compensating element to be integrated into just a single, one-piece component. The compensating element can therefore preferably be significantly lighter than conventional designs, which can make higher dynamics possible in handling applications. The significantly reduced complexity also means that costs can be significantly reduced, making the application much more economical. The design of the compensating element can also be used advantageously for many different handling applications, such as gripping applications.

In one exemplary embodiment, the at least one compensating element is formed from a plurality of adjacent, preferably additively manufactured, material layers, preferably made of a plastic, e.g. a thermoplastic polyurethane, polyamide, e.g. PA12, PA6; or other usual materials. This advantageously makes possible a particularly simple and rapid production of the compensating element, even in a quantity of one, without the need for special production tools. A further advantage is that the compensating element can be adapted particularly easily, e.g. with regard to the desired restoring forces, to the application-specific stress, etc.

In a further exemplary embodiment, the connectors are designed as webs (spokes). Optionally, the webs can extend in an arc, preferably a spiral arc, between the frame and the toolholder. Advantageously, the webs can make possible a simple and reliable design of the connectors. Advantageously, the arcuate shape of the webs can make comparatively long webs possible, with which a desired elastic mobility and restoring force can be provided very precisely as desired.

Alternatively, the connectors can be annular, bubble-shaped or wavy. Advantageously, the connectors can therefore be designed to be comparatively rigid in order to limit the maximum elastic mobility of the toolholder.

In a further embodiment, the connectors each merge at one end (e.g. tangentially) into an outer peripheral surface of the toolholder and at the other end (e.g. tangentially) into an inner peripheral surface of the frame. This advantageously makes possible gentle compression movements of the connectors and reduced stress at the transitions.

In one embodiment, the at least one compensating element has a plurality of, preferably two or three, compensating elements which are connected to one another, preferably as a single piece. Advantageously, a plurality of grippers—and thus a plurality of handling operations—can be carried out simultaneously. The previously explained advantages of low weight, low complexity, etc. can be exploited in multiple ways, which in some applications makes it possible to use multiple grippers on a single handling device. Advantageously, a plurality of grippers can also be accommodated in the toolholders, and thus a plurality of objects, such as container turntables, can be gripped simultaneously, such that individual inaccuracies in the position of the grippers and of the objects can be compensated for by the compensating elements. This can advantageously make possible a particularly time-saving handling of the objects.

Preferably, the plurality of compensating elements can be arranged next to one another, preferably in a row next to one another. Alternatively or additionally, the plurality of compensating elements can be arranged, for example, in a common alignment plane.

In a further embodiment, the toolholders of the plurality of compensating elements each have a center point, and the center points lie on an imaginary circular arc. Advantageously, the arrangement of the center points on the imaginary circular arc can be adapted to a rotary container processing device and its pitch circle. Preferably, the apparatus can thus be used particularly efficiently with this rotary container processing device.

In one embodiment variant, the apparatus further comprises a housing which connects the plurality of compensating elements to one another, preferably by means of a plurality of webs, wherein the housing optionally comprises a flange section for attaching the apparatus to the handling device. Advantageously, the plurality of compensating elements can be reliably integrated into a single component in this way.

In a further embodiment variant, the housing is integrally connected as a single piece to the multiple compensating elements, and/or the multiple compensating elements and the housing are formed together from multiple adjacent, preferably additively manufactured, material layers, preferably made of a plastic, e.g. a thermoplastic polyurethane, polyamide, e.g. PA12, PA6; or other usual materials. This advantageously enables particularly simple and rapid production of the compensating elements and the housing, even in very small quantities, without the need for special production tools. A further advantage is that the housing and the compensating elements can be adapted to suit the specific application particularly easily.

In one exemplary embodiment, the apparatus further comprises at least one mechanical stop which limits an elastic mobility of the toolholder within the frame. This can advantageously protect the connectors from overloading and fracture or limit the compensating for movements, thereby protecting the toolholder from an undesirably large movement.

In another exemplary example:
the at least one mechanical stop is detachably or integrally connected as a single piece to the at least one compensating element, preferably the toolholder of the at least one compensating element; and/or
the at least one mechanical stop is connected to the toolholder for the purpose of movement with the toolholder; and/or
the at least one mechanical stop surrounds the frame with a gap between the at least one mechanical stop and the frame (for example, to provide clearance for the toolholder); and/or
the at least one mechanical stop is designed as a raised, preferably curved, edge of a plate extending from the toolholder, which edge abuts the frame to limit the elastic mobility (e.g. externally).

Advantageously, a particularly simple and reliable construction of the at least one mechanical stop can be provided in this way.

In one embodiment variant, the at least one compensating element further comprises an elastically deformable bellows which surrounds the toolholder, preferably coaxially, and is inflatable for the purpose of returning and/or arresting the toolholder. Advantageously, this makes it possible to return the toolholder to its central position and/or to arrest the toolholder in its central position by means of pneumatic control of the bellows.

Optionally, the toolholder, the frame, the multiple connectors and the elastically deformable bellows can be integrally connected as a single piece to one another.

Optionally, the elastically deformable bellows can have an (e.g. annular) inner conical section which is opposite an (e.g. annular) outer conical section of the toolholder.

In a further embodiment variant, the apparatus further comprises at least one gripper, preferably a hole gripper or external gripper (e.g. parallel gripper), which is accommodated in the toolholder of the at least one compensating element, preferably detachably or integrally as a single piece.

In one exemplary embodiment, the apparatus further comprises a plurality of, preferably rod-shaped, spacers for positioning and orienting an object held by the at least one gripper. This can advantageously prevent unwanted tilting or wobbling of the gripped object during handling.

A further aspect of the present disclosure relates to a container processing system comprising a container processing device (e.g. container labeling device), preferably a rotary container processing device (e.g. rotary container labeling device). The container processing system further comprises a handling device with an apparatus as disclosed herein, wherein the handling device is designed to handle containers or components, preferably container turntables, format parts, or fitting parts, of the container processing device. Advantageously, the container processing system can achieve the same advantages as already described with reference to the apparatus. Application in a container processing system can be particularly advantageous, since the requirements made of it can be fully met by the compensating element, despite its simple design.

Preferably, the imaginary circular arc on which the center points of the toolholders lie can be a part (a circular segment) of a circle whose diameter is identical to a pitch circle of the rotary container processing device. As already mentioned, the apparatus can thus be advantageously structurally adapted to a rotary container processing device and its pitch circle, and can thus be used particularly efficiently with this rotary container processing device.

For example, the container processing system can be designed for the production, cleaning, coating, testing, filling, closing, labeling, printing and/or packaging of containers for liquid media, preferably beverages or liquid foodstuffs.

Preferably, the containers can be designed as bottles, cans, canisters, cartons, flacons, tubes etc.

A further aspect of the present disclosure relates to a method for producing an apparatus as disclosed herein. The apparatus comprises an additive manufacturing of the at least one compensating element and optionally the housing, of the at least one mechanical stop, and/or of the at least one gripper, to form a one-piece body, preferably in a powder bed process and/or made from a plastic, preferably a thermoplastic polyurethane, polyamide, e.g. PA12, PA6; or other usual materials. Advantageously, the method can achieve the same advantages as already described with reference to the apparatus.

A further aspect of the present disclosure relates to a computer program product comprising instructions that cause an additive manufacturing device to produce an apparatus as disclosed herein in multiple layers in an additive manufacturing process, preferably a powder bed process, or to carry out a method as disclosed herein.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a perspective view of an apparatus according to an exemplary embodiment of the present disclosure;

FIG. 2 shows a top view of the apparatus of FIG. 1;

FIG. 3 shows a sectional view through the apparatus of FIG. 1;

FIG. 4 shows a perspective view of an apparatus according to an exemplary embodiment of the present disclosure;

FIG. 5 shows a perspective sectional view through an apparatus according to an exemplary embodiment of the present disclosure;

FIG. 6 shows a perspective view of an apparatus according to an exemplary embodiment of the present disclosure;

FIG. 7 shows a top view of the exemplary apparatus of FIG. 6;

FIG. 8 shows a perspective view of the exemplary apparatus of FIG. 6, equipped with tools;

FIG. 9 shows a further perspective view of the exemplary apparatus of FIG. 8;

FIG. 10 shows a sectional view through the exemplary apparatus of FIG. 8; and

FIG. 11 shows a perspective view of the exemplary apparatus of FIG. 6, equipped with tools;

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

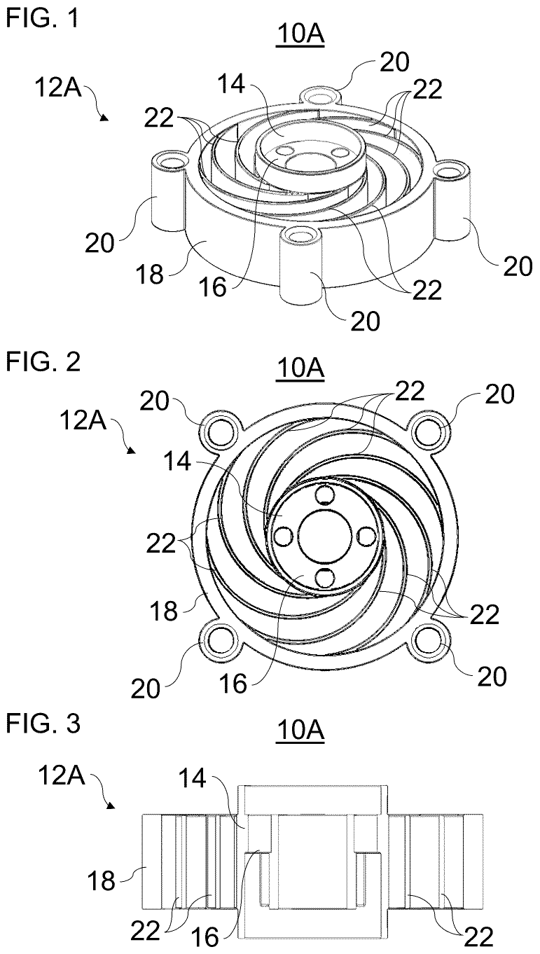

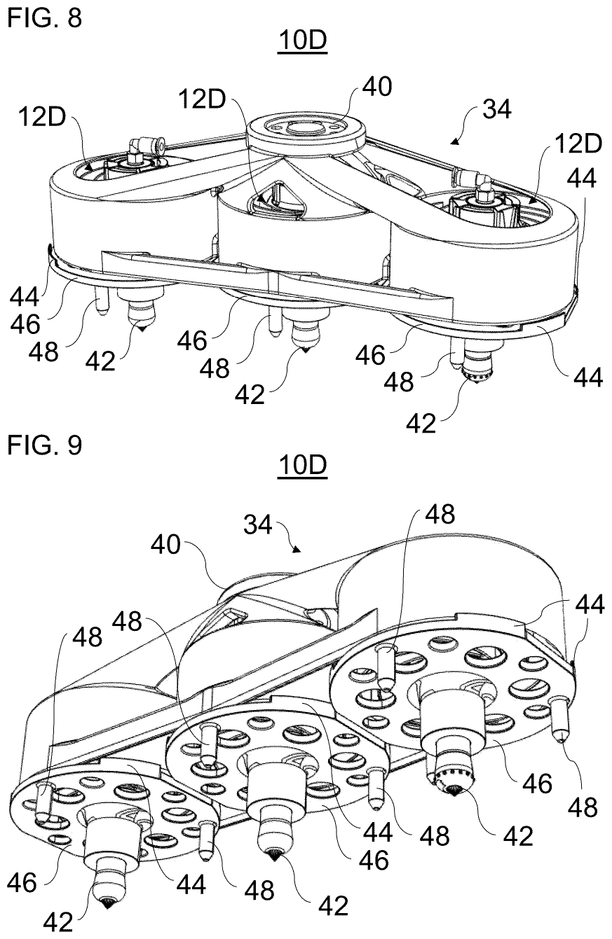

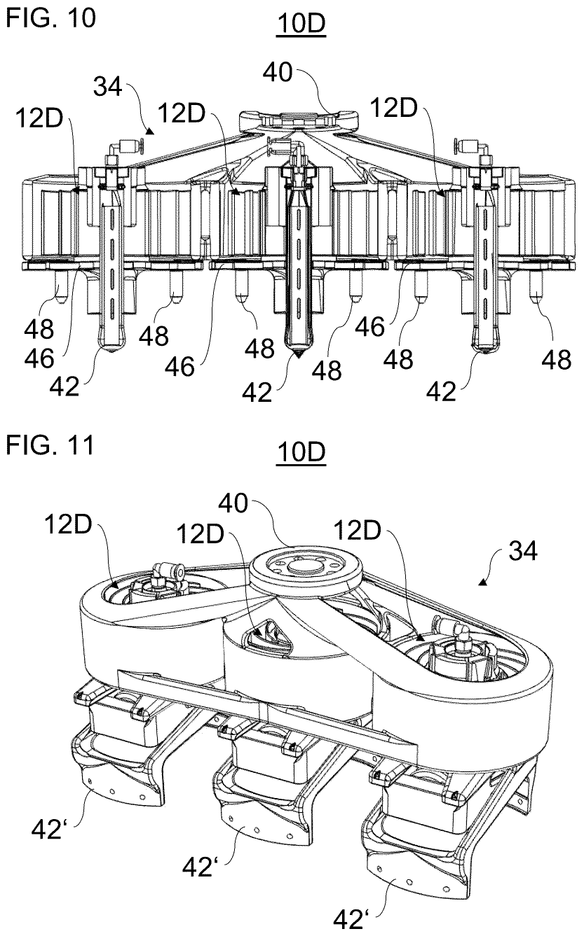

FIGS. 1 to 11 show apparatuses 10A-10D for connecting at least one gripper 42 to a handling device for the purpose of compensating for position inaccuracies. For the sake of clarity, the grippers 42 are only shown in FIGS. 8 to 11.

In detail, the apparatuses 10A-10D each have at least one, preferably disk-shaped, compensating element 12A-12D for the purpose of compensating for the position inaccuracies. It is possible that the apparatuses 10A-10D have further elements in addition to the compensating element 12A-12D, as described herein by way of example with reference to FIG. 8ff.

The handling device can be, for example, a stationary or mobile robot or any other type of handling device. For example, the handling device can have a pivotable and/or displaceable arm. The apparatus 10A-10D can be attached to the arm, e.g. at one end of the arm. The at least one gripper 42 can be attached to the arm and preferably carried via the apparatus 10A-10D.

Preferably, each apparatus 10A-10D, together with the at least one gripper 42, can form an end effector for the handling device (see FIGS. 8 to 11).

Preferably, each apparatus 10A-10D can be used together with the handling device in a container processing system. For example, the apparatus 10A-10D can be equipped with at least one gripper 42 for gripping at least one container turntable. It is also possible for the gripper 42 to be used, for example, to grip containers, fitting parts or format parts in a container processing system. It is also possible for the apparatus 10A-10D to be used in an environment other than a container processing system to compensate for position inaccuracies.

Particularly preferably, the at least one compensating element 12A-12D is formed from a plurality of adjacent, additively manufactured material layers. The at least one compensating element 12A-12D can be additively manufactured to form a one-piece body. Preferably, the at least one compensating element 12A-12D can be additively manufactured in a powder bed process. Preferably, the material layers may be made of a plastic, preferably of a thermoplastic polyurethane, a polyamide or other usual materials.

Instructions for causing an additive manufacturing facility to additively manufacture the at least one compensating element 12A-12D (or the apparatus 10A-10D) can be stored in a computer program product (e.g. file(s) or data carrier with file(s)).

FIGS. 1 to 3 show the apparatus 10A with the compensating element 12A.

The compensating element 12A has a toolholder 14, a frame 18 and a plurality of connectors 22.

Preferably, the toolholder 14, the frame 18 and the connectors 22 can lie in a common plane or position. Together, the toolholder 14, the frame 18 and the connectors 22 can result in a disk-shaped configuration of the compensating element 12A.

The toolholder 14, the frame 18 and the connectors 22 are integrally connected as a single piece to one another. Accordingly, the compensating element 12A can be one-piece. The toolholder 14, the frame 18 and the connectors 22 can together form a one-piece body. In detail, the toolholder 14, the frame 18 and the connectors 22 can be formed together from a plurality of adjacent, additively manufactured material layers.

The toolholder 14 is designed to accommodate a gripper. For example, the gripper not shown in FIGS. 1 to 3 (or 4 to 7) for reasons of better clarity can be designed like one of the grippers 42 shown in FIGS. 8 to 11.

For example, the gripper can be mounted directly on the toolholder 14. Alternatively, the gripper can be mounted indirectly on the toolholder 14, e.g. by means of an adapter, a tool housing or a toolholder.

The toolholder 14 is preferably annular or tubular (e.g. with a circular outer contour). The toolholder 14 can have a substantially cylindrical receiving space for the gripper. The gripper can be accommodated in an interior of the annular shape. For example, the gripper can be mounted centrally in the toolholder 14.

The gripper can be detachably attached to the toolholder 14. For example, the gripper can be attached to the toolholder 14 in a force-fitting and/or form-fitting manner. Preferably, the gripper can be attached to the toolholder 14 by means of a snap-in, plug-in or screwed connection.

For example, the toolholder 14 can have a fastening section 16 for fastening the gripper. Preferably, the fastening section 16 can be arranged on an inner peripheral surface of the annular or tubular toolholder 14.

Preferably, the fastening section 16 can, for example, have an annular support plate for supporting the gripper.

Alternatively or additionally, the fastening section 16 can, for example, have at least one screw hole for a screwed connection with the gripper, at least one locking element for a locking connection with the gripper and/or at least one plug-in element for a plug-in connection with the gripper. Preferably, a plurality of screw holes, a plurality of locking elements and/or a plurality of plug-in elements are included. For example, the plurality of screw holes, the plurality of locking elements and/or the plurality of plug-in elements can be arranged on an inner peripheral side of the annular toolholder 14, preferably equidistantly from one another.

It is possible that the plurality of screw holes, the plurality of locking elements and/or the plurality of plug-in elements are arranged in or on the annular support plate of the fastening section 16.

The frame 18 serves to connect the compensating element 12A to the handling device.

The frame 18 surrounds the toolholder 14 as a frame. Preferably, the frame 18 and the toolholder 14 are arranged coaxially. Preferably, the frame 18 is annular.

The frame 18 may be arranged spaced apart from the toolholder 14. Preferably, an annular gap can be arranged between an inner peripheral surface of the frame 18 and an outer peripheral surface of the toolholder 14.

Preferably, the frame 18 can support the toolholder 14 via the connectors 22.

The frame 18 can be detachably attached to the handling device. For example, the frame 18 can be attached to the handling device in a force-fitting and/or form-fitting manner. Preferably, the frame 18 can be attached to the handling device by means of a snap-in, plug-in or screwed connection.

For example, the frame 18 may have at least one fastening section 20 for fastening to the handling device. Preferably, the at least one fastening section 20 can be arranged on an outer peripheral surface of the frame 18.

Preferably, the at least one fastening section 20 can, for example, have at least one screw hole for a screwed connection with the handling device, at least one locking element for a locking connection with the handling device and/or at least one plug-in element for a plug-in connection with the handling device. Preferably, a plurality of screw holes, a plurality of locking elements and/or a plurality of plug-in elements are included. For example, the plurality of screw holes, the plurality of locking elements and/or the plurality of plug-in elements can be arranged on an outer peripheral side of the frame 18, preferably equidistantly from one another.

However, it is also possible that the frame 18 itself is not directly attached to the handling device. Instead, an additional element, such as a housing or a bracket, can attach the frame 18 to the handling device. The additional element can be formed separately from the frame 18 and, for example, attached to the frame 18 by means of at least one fastening section 20. Alternatively or additionally, the additional element can, for example, be formed integrally with the frame 18 as a single piece.

The connectors 22 are elastically deformable, preferably elastically flexible. The connectors 22 connect the toolholder 14 to the frame 18 in an elastically movable manner. The toolholder 14 is elastically movable within the frame 18, due to the connectors 22.

The connectors 22 can be designed to allow movement of the toolholder 14 relative to the frame 18 to a predetermined extent. When a force acts on the gripper and thus on the toolholder 14, the connectors 22 can (only) deform elastically. After a decrease in the force, the connectors 22 and thus the toolholder 14 can return to their original positions. Preferably, a spring hardness and restoring force exerted by the connectors 22 in the individual spatial directions can be determined by appropriate dimensioning and design of the connectors 22.

The elastic deformability of the connectors 22 can substantially exist in an alignment plane of the compensating element 12A or a plane perpendicular to a central axis (main central axis) of the compensating element 12A. In addition, for example, the connectors 22 can be elastically deformable in a direction perpendicular to the alignment plane of the compensating element 12A or parallel to a central axis (main central axis) of the compensating element 12A.

Accordingly, the mobility of the toolholder 14 can substantially exist in the alignment plane of the compensating element 12A or the plane perpendicular to the central axis of the compensating element 12A, and optionally additionally perpendicular thereto.

Preferably, the connectors 22 can be arranged inside the frame 18 and outside the toolholder 14. For example, the connectors 22 can be arranged in an annular gap formed between the frame 18 and the toolholder 14. Preferably, the connectors 22 can be arranged, preferably evenly, distributed around an outer peripheral surface of the toolholder 14.

Preferably, the connectors 22 are designed as webs (spokes). Preferably, the connectors 22 can extend in an arc, particularly preferably in a spiral arc, between the frame 18 and the toolholder 14. A radius of an arc shape of a respective connector 22 may be smaller than a radius of the frame 18 and/or may be larger than a radius of the toolholder 14.

At one end, the connectors 22 can each merge into an outer peripheral surface of the toolholder 14. Preferably, this transition from the connector 22 into the outer peripheral surface of the toolholder 14 can be tangential.

At an opposite end, the connectors 22 can each merge into an inner peripheral surface of the frame 18. Preferably, this transition from the connector 22 into the inner peripheral surface of the frame 18 can be tangential.

The connectors 22 can support the toolholder 14 and thus the gripper received therein on the frame 18.

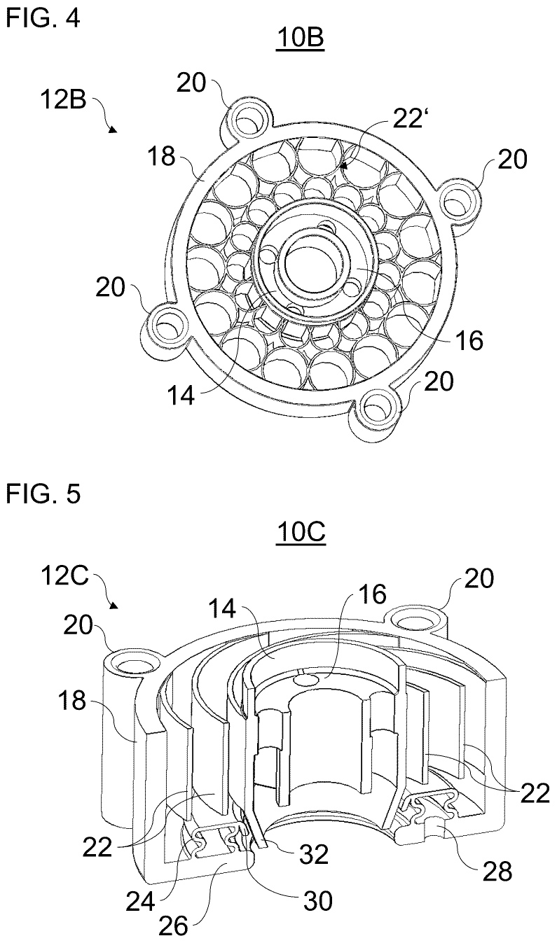

FIG. 4 shows the apparatus 10B with the compensating element 12B.

The compensating element 12B may be similar to the compensating element 12A described with reference to FIGS. 1 to 3. A difference between the compensating element 12B and the compensating element 12A may be that the connectors 22′ of the compensating element 12B are substantially annular or bubble-shaped or wavy.

The connectors 22′ are in turn elastically deformable to provide elastic mobility of the toolholder 14 within the frame 18.

FIG. 5 shows the apparatus 10C with the compensating element 12C.

The compensating element 12C may be similar to the compensating element 12A described with reference to FIGS. 1 to 3. A difference between the compensating element 12C and the compensating element 12A may be that the compensating element 12C additionally has a bellows 24.

The bellows 24 can surround the toolholder 14, preferably coaxially. Preferably, the bellows 24 may be substantially annular.

For example, the bellows 24 can be arranged in an annular gap formed between the frame 18 and the toolholder 14. For example, the bellows 24 can be arranged below or above the connectors 22.

The bellows 24 can, for example, be supported by an annular plate 26. The plate 26 can be connected to the frame 18 on its outer circumference. Preferably, the plate 26 can merge on its outer circumference into an end surface of the frame 18 and/or into an inner peripheral surface of the frame 18. The plate 26 can be supported by the frame 18. The plate 26 can carry the bellows 24.

The bellows 24 can be elastically deformable. The bellows 24 may be inflatable to arrest (fix) and/or return the tool holder 14 within the frame 18.

For example, the inflated bellows 24 can abut an outer peripheral surface of the toolholder 14. The inflated bellows 24 can compel the toolholder 14 to assume a central position within the frame 18.

The bellows 24 can be connected to a compressed air connection 28 for supplying compressed air to the bellows 24. It is possible that the bellows 24 can also be relieved via the compressed air connection 28.

A compressed air line can be connected to the compressed air connection 28 (not shown in the figures). The bellows 24 can be supplied with compressed air for inflation via the compressed air line. The compressed air line can be detachably connected to the compressed air connection 28. For example, the compressed air line can be connected to the compressed air connection 28 in a force-fitting and/or form-fitting manner. For example, the compressed air connection 28 and the compressed air line can be detachably connected to one another via a screwed or clamped connection.

The compressed air connection 28 can preferably open directly into the bellows 24. Alternatively, for example, a connecting channel can connect the compressed air connection 28 and the bellows 24.

Preferably, the compressed air connection 28 may be arranged in the plate 26.

The bellows 24 can be inflatable due to its low wall thickness. For example, an outer wall of the bellows 24 can have a smaller wall thickness than the compressed air connection 28 or the optional connecting channel between the compressed air connection 28 and the bellows 24. For example, the bellows 24 can have a wall thickness ≤2 mm, ≤1.5 mm or ≤1 mm.

Preferably, the bellows 24 can be shaped on its inner peripheral side to match an opposite outer peripheral side of the tool holder 14.

For example, the bellows 24 can have an inner conical section 30. The inner conical section 30 can be arranged on an inner peripheral side of the bellows 24. The inner conical section 30 can be directly opposite an outer conical section 32 of the tool holder 14. The inner conical section 30 may be annular. The inner conical section 30 can, for example, be designed as a circumferential lip. The outer conical section 32 can also be annular. The outer conical section 32 can be arranged, for example, at one end, e.g. upper or lower, of the tubular or annular toolholder 14.

Preferably, the bellows 24 can be inflated when compressed air is applied to the bellows 24. As a result, the inner conical section 30 acting as a restoring cone can be moved, e.g. upwards, and pressed against the outer conical section 32 of the toolholder 14. The force acting in this case can lead to a return of the toolholder 14 to its central position/zero position, e.g. in the center of the compensating element 12C, and optionally to an arrest in this position.

Particularly preferably, the toolholder 14, the frame 18, the plurality of connectors 22 and the bellows 24, and optionally the plate 26, are integrally connected as a single piece to one another. Accordingly, the compensating element 12C can again be one-piece. The toolholder 14, the frame 18, the connectors 22 and the bellows 24 and optionally the plate 26 can together form a one-piece body. In detail, the toolholder 14, the frame 18, the connectors 22, the bellows 24 and optionally the plate 26 can be formed together from a plurality of adjacent, additively manufactured material layers.

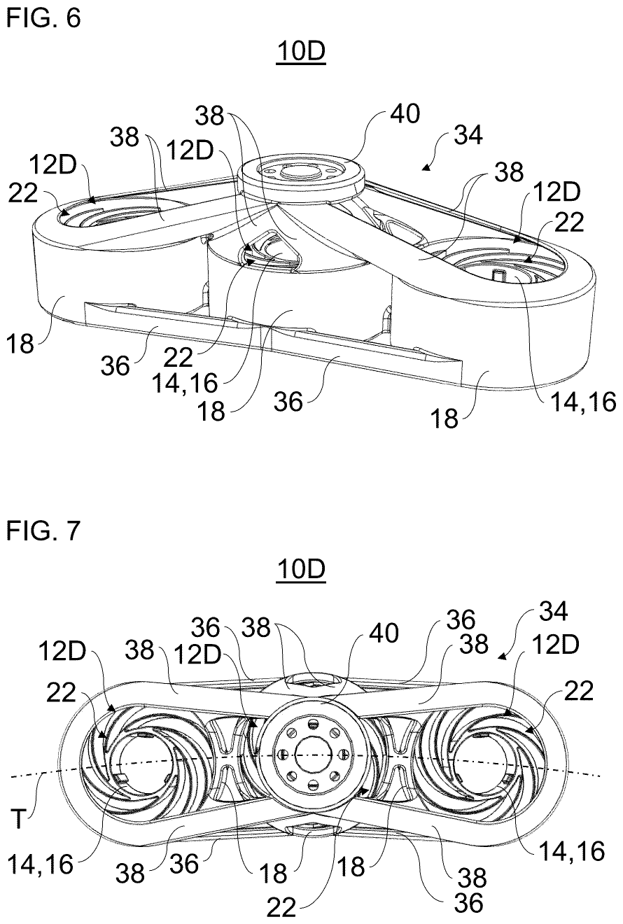

FIGS. 6 to 11 show the apparatus 10D.

The apparatus 10D has a plurality of compensating elements 12D, e.g. three compensating elements 12D as shown.

The compensating elements 12D can be connected to each other. Preferably, the compensating elements 12D are integrally connected as a single piece to one another. For example, the compensating elements 12D may be integrally connected as a single piece to one another on the outer peripheral surfaces of their respective frames 18. The outer peripheral surfaces of the frames 18 can preferably merge into one another.

The compensating elements 12D can be arranged next to one another, preferably in a row. Preferably, the center points of the toolholders 14 of the compensating elements 12D do not lie on a straight line. Instead, it is preferred that the center points of the toolholders 14 lie on an imaginary circular arc (see FIG. 7). The circular arc may be a part (a circular segment) of a circle whose diameter is identical to a diameter of a pitch circle T of a rotary container processing device with which the apparatus 10D is to be used.

The apparatus 10D may include a housing 34.

The housing 34 can connect the compensating elements 12D to each other. Preferably, the housing 34 connects the compensating elements 12D integrally as a single piece to one another. The housing 34 and the compensating elements 12D can be formed together from a plurality of adjacent, additively manufactured material layers, preferably made from a plastic, e.g. a thermoplastic polyurethane.

Preferably, the housing 34 can have a spatial frame structure at least in portions thereof. The compensating elements 12D can be integrally connected as a single piece to one another via the spatial frame structure.

The housing 34 can at least partially cover the compensating elements 12D. The housing 34 can, for example, at least partially cover an upper side of the compensating elements 12D, or a side thereof facing the handling device.

For example, the housing 34 may have a plurality of webs 36, a plurality of webs 38 and/or a flange section 40, which may preferably be integrally connected as a single piece to one another.

The webs 36 can connect the frames 18 of the compensating elements 12D integrally as a single piece. For example, the webs 36 can each merge at one end into an outer peripheral surface of a frame 18 of a compensating element 12D, and at an opposite end into an outer peripheral surface of a frame 18 of another compensating element 12D. Preferably, the transitions can be made tangentially. Preferably, the webs 36 may be substantially parallel to an alignment plane of the compensating elements 12D.

The webs 38 can integrally connect the frames 18 of the compensating elements 12D to the flange section 40 as a single piece. For example, the webs 38 can be arranged on an upper side of the compensating elements 12D, or a side thereof facing the handling device. For example, the webs 38 can each merge at one end into an end face and/or outer peripheral surface of a frame 18 of a compensating element 12D, and merge at an opposite end into the flange section 40. Preferably, the webs 38 can be angled with respect to an alignment plane of the compensating elements 12D.

The flange section 40 may be arranged centrally with respect to a longitudinal extension of the apparatus 10D. For example, the flange section 40 may be arranged in alignment with a centrally arranged compensating element 12D of the plurality of compensating elements 12D. Preferably, the flange section 40 is arranged at a distance from the compensating elements 12D and connected to them via the webs 38.

By means of the flange section 40, the apparatus 10D can be attached to the handling device, e.g. as an end effector. Preferably, the flange section 40 can, for example, have at least one screw hole for a screwed connection with the handling device, at least one locking element for a locking connection with the handling device and/or at least one plug-in element for a plug-in connection with the handling device. Preferably, a plurality of screw holes, a plurality of locking elements and/or a plurality of plug-in elements are included. For example, the plurality of screw holes, the plurality of locking elements and/or the plurality of plug-in elements can be arranged on an end face of the flange section 40, preferably equidistantly from one another on an imaginary circular line.

Preferably, the flange section 40 may be substantially disk-shaped.

FIGS. 8 to 10 show the apparatus 10D equipped with a plurality of grippers 42. For better clarity, some reference symbols have been omitted in FIGS. 8 to 10.

The grippers 42 are preferably designed as hole grippers. The hole gripper can also be called an expansion gripper, a bellows gripper or an internal gripper.

The hole gripper can be used to grip and handle an object (e.g. workpiece or container), e.g. a container turntable, a format part, a fitting part or a container. The hole gripper can grip the object in or at a hole in the object. The hole gripper can clamp itself into the hole with a positive and non-positive fit. The clamped object can be moved by the handling device together with the hole gripper.

The hole gripper can, for example, be equipped with an inflatable bellows. Here, an overpressure can be created inside, allowing the bellows to inflate like a balloon. The bellows can abut the inner wall of a hole and thus establish frictional contact with the object to be transported. Alternatively, the hole gripper can, for example, have an elastically deformable element. Here a plunger can be pulled or pushed by a pneumatic drive. The plunger can compress the elastically deformable element. This compression can also create a frictional contact with the inner wall of the hole.

Preferably, the at least one gripper 42 is detachably attached to the fastening section 16 of the toolholder 14 of the at least one compensating element 12D, e.g. one gripper 42 per toolholder 14.

Alternatively, however, it is also possible, for example, that the at least one gripper 42 and the toolholder 14 of the at least one compensating element 12D are integrally connected as a single piece to one another. For example, the at least one gripper 42 and the at least one compensating element 12D can be formed together from a plurality of adjacent, preferably additively manufactured, material layers, preferably made from a plastic, e.g. a thermoplastic polyurethane.

As shown by way of example using the apparatus 10D in FIGS. 8 to 10, at least one mechanical stop 44 can be included per compensating element 12D.

The at least one mechanical stop 44 can limit an elastic mobility of the toolholder 14 within the frame 18. For this purpose, the at least one mechanical stop 44 can preferably be attached to the outside of the frame 18.

Preferably, the at least one mechanical stop 44 can encompass the frame 18 with a gap between the at least one mechanical stop 44 and the frame 18. Depending on the dimensioning of the gap, the elastic mobility of the toolholder 14 within the frame 18 can be limited.

Preferably, the at least one mechanical stop 44 can be designed as a raised edge of a plate 46 extending from the toolholder 14. The plate 46 may preferably be disk-shaped or annular. The plate 46 can be detachably or integrally connected as a single piece to the corresponding compensating element 12D, the housing 34 or the gripper 42. The edge can extend in an arc, preferably adapted to the shape of an outer peripheral surface of the frame 18.

For example, the at least one mechanical stop 44 can move with the toolholder 14 of the respective compensating element 12, while the toolholder 14 moves within the frame 18. The at least one mechanical stop 44 can move until it strikes the frame 18, e.g. on the outside, and thus limits the elastic mobility of the toolholder 14 and thus of the gripper 42.

The at least one mechanical stop 44 can be detachably connected to the at least one compensating element 12D. For example, the at least one mechanical stop 44 can be detachably connected via the plate 46 to the toolholder 14 and/or the gripper 42 received in the toolholder 14.

Alternatively, however, it is also possible, for example, for the at least one mechanical stop 44 and the at least one compensating element 12D to be integrally connected as a single piece to one another, e.g. via the plate 46 and/or the toolholder 14. For example, the at least one mechanical stop 44 and the at least one compensating element 12D can be formed together from a plurality of adjacent, preferably additively manufactured, material layers, preferably made from a plastic, e.g. a thermoplastic polyurethane.

Preferably, a plurality of mechanical stops 44 are included per compensating element 12D. For example, the plurality of mechanical stops 44 per compensating element 12D can be arranged distributed around an outer peripheral surface of the frame 18.

As is also shown by way of example with reference to the apparatus 10D in FIGS. 8 to 10, a plurality of spacers 48 can be included.

The spacers 48 can preferably be rod-shaped. By means of the spacers 48, the object gripped by the respective gripper 42 can be positioned as desired. For this purpose, the free ends of the spacers 48 can contact the object, e.g. an upper side of the object.

The spacers 48 can extend towards the object to be gripped or parallel to a central axis of the respective gripper 42.

The spacers 48 can be arranged, for example, on the plate 46, the housing 34, the compensating element 12D and/or the gripper 42. It is possible that the spacers 48 are integrally connected as a single piece to the at least one compensating element 12D.

FIG. 11 shows the apparatus 10D equipped with a plurality of grippers 42′. For better clarity, some reference symbols are omitted in FIG. 11.

The grippers 42′ from FIG. 11 can be designed as so-called external grippers, preferably parallel grippers.

The parallel gripper can, for example, have two gripping jaws. When actuated, the two gripping jaws can be moved towards each other to grip an object. The two gripping jaws can be moved away from each other to release the gripped object.

It is understood that the individual features of the apparatuses 10A, 10B, 10C and 10D can be combined with one another as desired and are interchangeable.

The invention is not limited to the preferred exemplary embodiments described above. Rather, a plurality of variants and modifications are possible which likewise make use of the inventive concept and therefore fall within the scope of protection. In particular, the invention also claims protection for the subject-matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the compensating element, of the toolholder, of the frame, and/or of the connectors of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10A-10D apparatus
12A-12D compensating element
14 toolholder
16 fastening section
18 frame
20 fastening section
22 connector
24 bellows
26 plate
28 compressed air connection
30 inner conical section
32 outer conical section
34 housing
36 strut
38 strut
40 flange section
42 gripper
44 mechanical stop
46 plate
48 spacer
T pitch circle

What is claimed is:

1. An apparatus for connecting a gripper to a handling device, the apparatus comprising:
at least one compensating element for the purpose of compensating for position inaccuracies, with:
a toolholder for holding the gripper,
a frame for connecting the compensating element to the handling device, wherein the frame surrounds the toolholder as a frame, and
a plurality of elastically deformable connectors which connect the toolholder inside the frame to the frame in an elastically movable manner,
wherein the toolholder, the frame and the plurality of connectors are integrally connected as a single piece to one another.

2. The apparatus according to claim 1, wherein at least one of:
the handling device includes a handling robot;
the compensating element is substantially disk-shaped;
the toolholder is one of annular and tubular;
the frame is annular; and
the frame coaxially surrounds the toolholder.

3. The apparatus according to claim 1, wherein:
the at least one compensating element is formed from a plurality of adjacent material layers.

4. The apparatus according to claim 1, wherein one of:
the connectors are designed as webs and the webs extend in an arc between the frame and the toolholder, and
the connectors are one of annular, bubble-shaped and wavy.

5. The apparatus according to claim 1, wherein:
the connectors each merge at one end into an outer peripheral surface of the tool holder and at the other end into an inner peripheral surface of the frame.

6. The apparatus according to claim 5, wherein:
the toolholders of the plurality of compensating elements each have a center point, and
the center points lie on an imaginary circular arc.

7. The apparatus according to claim 1, wherein:
the at least one compensating element has a plurality of compensating elements which are connected to one another.

8. The apparatus according to claim 7, further comprising:
a housing which connects the plurality of compensating elements to one another, the housing having a flange section for attaching the apparatus to the handling device.

9. The apparatus according to claim 8, wherein at least one of:
the housing connects the plurality of compensating elements to one another via a plurality of webs;
the plurality of compensating elements and the housing are together formed from a plurality of adjacent additively manufactured material layers made from a plastic; and
the plurality of compensating elements and the housing are together formed from a plurality of adjacent additively manufactured material layers made from one of a thermoplastic polyurethane and a polyamide.

10. The apparatus according to claim 1, wherein at least one of:
the at least one compensating element is formed from a plurality of adjacent additively manufactured material layers made from a plastic
the at least one compensating element is formed from a plurality of adjacent additively manufactured material layers made from one of a thermoplastic polyurethane and a polyamide;
the connectors are designed as webs and the webs extend in a spiral arc between the frame and the toolholder; and
the at least one compensating element has one of two and three compensating elements which are connected to one another as a single piece.

11. The apparatus according to claim 10, wherein at least one of:
the housing is integrally connected as a single piece to the plurality of compensating elements; and
the plurality of compensating elements and the housing are together formed from a plurality of adjacent material layers.

12. The apparatus according to claim 1, further comprising:
at least one mechanical stop which limits an elastic mobility of the toolholder within the frame.

13. The apparatus according to claim 12, wherein at least one of the following is fulfilled:
the at least one mechanical stop is one of detachably and integrally connected as a single piece to the at least one compensating element;
the at least one mechanical stop is connected to the toolholder for the purpose of movement with the toolholder;
the at least one mechanical stop surrounds the frame with a gap between the at least one mechanical stop and the frame; and
the at least one mechanical stop is designed as a raised edge of a plate extending from the toolholder, which edge abuts the frame to limit the elastic mobility.

14. The apparatus according to claim 1, wherein:
the at least one compensating element further comprises an elastically deformable bellows which surrounds the toolholder and is inflatable for the purpose of at least one of returning and arresting the toolholder.

15. The apparatus according to claim 1, further comprising at least one of:
at least one gripper which is accommodated in the toolholder of the at least one compensating element; and
a plurality of spacers for positioning and orienting an object held by the at least one gripper.

16. The apparatus according to claim 1, wherein at least one of:
the at least one compensating element further comprises an elastically deformable bellows which coaxially surrounds the toolholder;
the toolholder, the frame, the plurality of connectors and the elastically deformable bellows are integrally connected as a single piece to one another;
the elastically deformable bellows has an inner conical section which is opposite an outer conical section of the toolholder;
the apparatus further comprises at least one hole gripper or external gripper which is detachably or integrally accommodated in the toolholder of the at least one compensating element as a single piece; and
the apparatus further comprises a plurality of rod-shaped spacers for positioning and orienting an object held by the at least one gripper.

17. A container processing system, comprising:
a container processing device; and
a handling device having an apparatus according to claim 1, wherein the handling device is designed to handle one of containers and components of the container processing device.

18. A method for producing an apparatus according to claim 1, comprising:
additively manufacturing the at least one compensating element.

19. The method according to claim 18, further comprising one of:
additively manufacturing at least one of the housing, the at least one mechanical stop, and the at least one gripper to form a one-piece body;
additively manufacturing at least one of the housing, the at least one mechanical stop, and the at least one gripper in a powder bed process to form the one-piece body;
additively manufacturing at least one of the housing, the at least one mechanical stop, and the at least one gripper to form the one-piece body made from a plastic; and
additively manufacturing at least one of the housing, the at least one mechanical stop, and the at least one gripper to form the one-piece body made from one of a thermoplastic polyurethane and a polyamide.

20. A computer program product having instructions causing an additive manufacturing apparatus to:
produce an apparatus according to claim 1 in multiple layers in an additive manufacturing method.
